(19) United States
(12) Patent Application Publication
(10) Pub. No.: US 2023/0216221 A1
(43) Pub. Date: Jul. 6, 2023

(54) CABLE CONNECTOR HAVING A RETAINING MEMBER FOR PROVIDING IMPROVED CONDUCTIVITY

(71) Applicant: PPC BROADBAND, INC., East Syracuse, NY (US)

(72) Inventor: Eric PURDY, Constantia, NY (US)

(73) Assignee: PPC BROADBAND, INC., East Syracuse, NY (US)

(21) Appl. No.: 18/091,598

(22) Filed: Dec. 30, 2022

Related U.S. Application Data
(60) Provisional application No. 63/295,004, filed on Dec. 30, 2021.

(51) Int. Cl. H01R 9/05; H01R 24/40

(52) U.S. Cl. CPC H01R 9/0521; H01R 9/0524; H01R 24/40

(57) ABSTRACT

A cable connector that may include a first coupler portion, a second coupler portion that may be configured to be coupled with the first coupler portion, an outer conductor engager portion that may be supported in at least a portion of the first coupler portion, and a retaining portion that may be configured to be received by the outer conductor engager portion. The first coupler portion may be configured to receive a cable, the retaining portion may comprise an engagement portion, and the retaining portion may be configured to engage the outer conductor engager portion and the retaining portion may be configured to engage the first portion so as to retain the outer conductor engager portion in the first coupler portion to restrain the outer conductor engager portion from separating from the first coupler portion before the second coupler portion is coupled to the first coupler portion and electrically connect the outer conductor engager portion to the first coupler portion so as to provide an electrical path from the cable to the first coupler portion during operation of the connector.

### CROSS-REFERENCE TO RELATED APPLICATION

This application claims the benefit of U.S. Provisional Application No. 63/295,004, which was filed on Dec. 30, 2021, the disclosure of which is hereby incorporated by reference herein in its entirety.

### BACKGROUND

The present invention relates generally to connectors for terminating coaxial cable. More particularly, the present invention relates to axially compressible connectors for hardline or semi-rigid coaxial cables.

Coaxial cables are commonly used in the cable television industry to carry cable TV signals to television sets in homes, businesses, and other locations. A hardline coaxial cable may be used to carry the signals in distribution systems exterior to these locations and a flexible coaxial cable is then often used to carry the signals within the interior of these locations. Hardline or semi-rigid coaxial cable is also used where a high degree of radio-frequency (RF) shielding is required.

Coaxial cable connectors are meant to create a constant electrical connection between two ground path components in hardline connectors to enhance RF signal integrity and connector RF shielding performance. It is important that a mandrel in these connectors floats so as not to create cable twist during connector installation on to the cable. This can be done by having the mandrel snap fit into a back nut. Due to the need to snap fit the mandrel and have the mandrel floating independent of, and not in direct contact with, the back nut, there is a need for improved RF shielding performance of hardline connectors.

The hardline cable includes a solid wire core or inner conductor, typically of copper or copper-clad aluminum, surrounded by a solid tubular outer conductor. The outer conductor is also usually made of copper or aluminum. Dielectric material or insulation separates the inner and outer conductors. The outer conductor is covered with a cable jacket or sheath of plastic to provide protection against corrosion and weathering.

Threaded cable connectors have been employed to provide even compression of the connector. Such connectors typically utilize some form of clamping mechanism that radially compresses the outer conductor of the cable against a tubular outer conductor engager (mandrel) upon axial threaded movement of the connector components to retain the cable in the hardline connector. The clamping mechanism may include a conical sleeve surrounded by an outer sleeve which forces the conical sleeve to radially compress upon axial movement of the outer sleeve with respect to the conical sleeve. The length of the conical closure sleeve typically closes the full length of the mechanism with equal forces around the circumference of the mandrel. The resulting forces closing down on the coaxial cable compress the cable around the outside of the mandrel creating a formed bond on the outside surface.

The above referenced, and other, connectors can provide an electrically conductive connection between the outer conductor of the coaxial cable and a back nut of the connector. However, this electrically conductive connection can be compromised by a poor contact between internal parts of the back nut and a housing of the back nut.

It may be desirable to provide a connector that overcomes one or more of the aforementioned disadvantages of hardline connectors. That is, it may be desirable to provide a connector having an improved electrically conductive connection between the outer conductor of the coaxial cable and the housing of the back nut.

### SUMMARY

In accordance with various embodiments of the disclosure, a coaxial cable connector has a retainer ring that has a main body that is configured to engage an outer surface of a mandrel and tabs that are configured to engage an inner surface of a back nut housing, thereby retaining the mandrel, a gripping ferrule, and a holder sleeve in the back nut housing to prevent the mandrel, the gripping ferrule, and the holder sleeve from separating from the back nut housing before a front nut assembly is coupled to the back nut housing, and electrically connecting the mandrel to the back nut housing to provide an electrical path from an outer conductor of a cable to the back nut housing.

Embodiments of the disclosure include a cable connector including: a back coupler housing having a rearward end and a forward end opposite the rearward end; a front coupler assembly configured to be coupled with the forward end of the back coupler housing; a tubular metal mandrel configured to be received within the back coupler housing and having a rearward end portion; and a retaining ring configured to be received in a groove in an outer surface of the mandrel. The main body of the retaining ring is configured to engage the outer surface of the mandrel, and the tabs are configured to engage an inner surface of the back coupler housing, thereby retaining the mandrel, the gripping ferrule, and the holder sleeve in the back coupler housing to prevent the mandrel, the gripping ferrule, and the holder sleeve from separating from the back coupler housing before the back coupler housing is coupled with the front coupler assembly and electrically connecting the mandrel to the back coupler housing to provide an electrical path from the outer conductor of the cable to the back coupler housing even before the back coupler housing is fully tightened to the front coupler assembly.

In embodiments, the rearward end of the back coupler housing is configured to receive a cable.

In embodiments, the retaining ring includes a main body and a plurality of tabs that are configured to protrude radially outward from the main body of the retaining ring.

In embodiments, the tabs are configured to be biased outwardly against the back coupler housing such that main body of the retaining ring is biased against the groove in the outer surface of the mandrel.

In embodiments, a compression assembly is configured to radially compress an outer conductor of the cable against the mandrel.

In embodiments, the compression assembly includes a tubular gripping ferrule that is configured to radially surround the mandrel and a tubular holder sleeve that is configured to radially surround at least a portion of the gripping ferrule.

In embodiments, the gripping ferrule is configured to be driven in an axial direction into engagement with the holder sleeve when the back coupler housing is threadedly coupled with the front coupler assembly, thereby causing the gripping ferrule to radially compress around the mandrel.

In embodiments, the back coupler housing includes an inner surface having an annular groove configured to receive the tabs of the retaining ring so as to limit axial movement of the mandrel relative to the back coupler housing.

In embodiments, the electrical path is provided when the back coupler housing is fully tightened to the front coupler assembly and during operation of the connector, and wherein the connector comprises a coaxial cable connector.

In embodiments, the electrical path is provided when the back coupler housing is loosely tightened to the front coupler assembly.

In embodiments, the electrical path is provided when the back coupler housing is partially tightened to the front coupler assembly and during operation of the connector.

In embodiments, the electrical path is provided when the back coupler housing is separated from the front coupler assembly and during operation of the connector.

In embodiments, the front coupler assembly comprises a front nut assembly; and wherein the back coupler housing comprises a back nut housing.

Embodiments of the disclosure include a cable connector including: a first portion having a rearward end and a forward end opposite the rearward end; a second portion configured to be coupled with the forward end of the first portion; an outer conductor engager portion configured to be supported within the first portion and having a rearward end portion; and a retaining portion configured to be received in a groove in an outer surface of the outer conductor engager portion. The main body of the retaining portion is configured to engage the outer surface of the outer conductor engager portion and the engagement portion is configured to engage an inner surface of the first portion, thereby retaining the outer conductor engager portion in the first portion to prevent the outer conductor engager portion from separating from the first portion before first portion is coupled with the second portion and electrically connecting the outer conductor engager portion to the first portion to provide an electrical path from the cable to the first portion even before the first portion is fully tightened to the second portion.

In embodiments, the rearward end of the first portion is configured to receive a cable.

In embodiments, the retaining portion includes a main body and an engagement portion that is configured to protrude radially outward from the main body of the retaining portion.

In embodiments, the electrical path is provided when the first portion is fully tightened to the second portion and during operation of the connector, wherein the connector comprises a coaxial cable connector, and wherein the electrical path is provided when the first portion is loosely tightened to the second portion and during operation of the connector.

In embodiments, the electrical path is provided when the first portion is partially tightened to the second portion and during operation of the connector.

In embodiments, the electrical path is provided when the first portion is separated from the second portion and during operation of the connector.

In embodiments, the first portion comprises a back nut housing, the second portion comprises a front nut assembly, the retaining portion comprises a retaining ring, and the engagement portion comprises a plurality of tabs, and wherein the connector comprises a coaxial cable connector.

In embodiments, the engagement portion is configured to be biased outwardly against the first portion such that the retaining portion is biased against the groove in the outer surface of the outer conductor engager portion.

Embodiments include a compression assembly that is configured to radially compress an outer conductor of the cable against the outer conductor engager portion.

In embodiments, the compression assembly includes a tubular gripping ferrule that radially surrounds at least a portion of the outer conductor engager portion and a tubular holder sleeve that radially surrounds at least a portion of the gripping ferrule, and the gripping ferrule is configured to be driven in an axial direction into engagement with the holder sleeve when the first portion is threadedly coupled with the second portion so as to cause the gripping ferrule to radially compress around the outer conductor engager portion.

In embodiments, the first portion includes an inner surface having an annular groove that is configured to receive the engagement portion of the retaining portion and to limit axial movement of the outer conductor engager portion relative to the first portion, and wherein the inner surface of the first portion comprises an annular lip that is configured to engage the engagement portion.

Embodiments of the disclosure include a connector including: a first coupler portion configured to receive a cable; a second coupler portion configured to be coupled with the first coupler portion; an outer conductor engager portion configured to be supported in at least a portion of the first coupler portion; and a retaining portion configured to be received by the outer conductor engager portion during assembly of the connector. The retaining portion is configured to engage the outer conductor engager portion so as to retain the outer conductor engager portion in at least a portion of the first coupler portion and restrict the outer conductor engager portion from separating from the first coupler portion before the second coupler portion is coupled to the first coupler portion and electrically connect the outer conductor engager portion to the first coupler portion so as to provide an electrical path from the cable to the first coupler portion during operation of the connector.

In embodiments, the retaining portion is configured to engage the first coupler portion.

In embodiments, the first coupler portion comprises a back nut housing portion, the second coupler portion comprises a front nut assembly, the outer conductor engage portion comprises a tubular mandrel, and the retaining portion comprises a retaining ring.

In embodiments, the electrical path is provided when the first coupler portion is fully tightened to the second coupler portion and during operation of the connector, and wherein the connector comprises a coaxial cable connector.

In embodiments, the electrical path is provided when the first coupler portion is loosely tightened to the second coupler portion and during operation of the connector, when the first coupler portion is partially tightened to the second coupler portion and during operation of the connector, and when the first portion is separated from the second portion and during operation of the connector.

In embodiments, the outer conductor engager portion is configured to be supported within the first coupler portion.

Embodiments include a compression assembly that is configured to radially compress an outer conductor of the cable against the outer conductor engager portion.

Various aspects of the connector, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a side cross-sectional view of an exemplary hardline connector in accordance with various aspects of the disclosure in a connected state.

FIG. 2 is a side cross-sectional view of the connector of FIG. 1 in a separated state.

FIG. 3 is an exploded perspective view of the connector of FIG. 1.

FIG. 4 is a partial side cross-sectional view of the connector of FIG. 1.

FIG. 5 is a perspective view of a retainer ring of the connector of FIG. 1.

FIG. 6 is a side view of the retainer ring of FIG. 5.

FIG. 7 is a side view of a mandrel of the connector of FIG. 1.

### DETAILED DESCRIPTION OF EMBODIMENTS

Embodiments of the disclosure provide a coaxial cable connector having a retainer ring that has a main body that is configured to engage an outer surface of a mandrel, and tabs are configured to engage an inner surface of a back coupler housing, thereby retaining the mandrel, a gripping ferrule, and a holder sleeve in the back coupler housing to prevent the mandrel, the gripping ferrule, and the holder sleeve from separating from the back coupler housing before the back coupler housing is coupled with a front coupler assembly and electrically connecting the mandrel to the back coupler housing to provide an electrical path from the outer conductor of a cable to the back coupler housing even before the back coupler housing is fully tightened to the front coupler assembly.

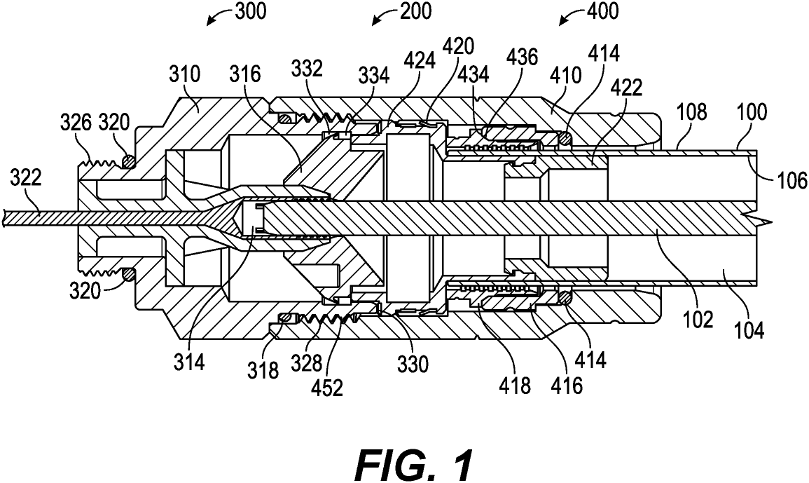

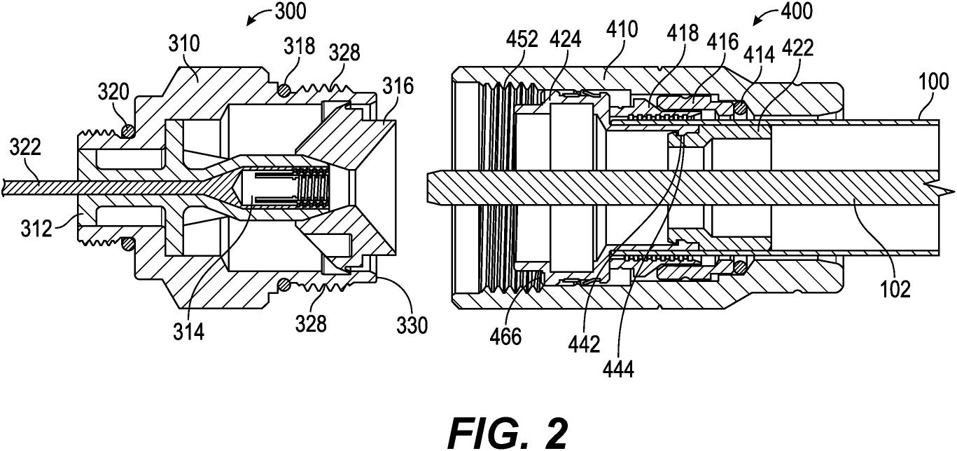

Referring FIG. 1, a connector 200 is depicted. The connector 200 is configured for hardline or semi-rigid coaxial cables. The connector 200 includes a front nut assembly 300 and a back nut assembly 400 that are configured to be removably connected to one another while providing both an electrical and mechanical connection therebetween.

As also shown in FIG. 1, a coaxial cable 100, for example, a hardline coaxial cable, is inserted into the rearward end of the back nut assembly 400 of the connector 200. Coaxial cables 100 generally include a solid center conductor 102 typically formed from a conductive metal, such as copper, copper clad aluminum, copper clad steel, or the like capable of conducting electrical signals therethrough. Surrounding the cable center conductor 102 is a cable dielectric 104, which insulates the cable center conductor to minimize signal loss. The cable dielectric 104 also maintains a spacing between the cable center conductor 102 and a cable outer conductor or shield 106. The cable dielectric 104 is often a plastic material, such as a polyethylene, a fluorinated plastic material, such as a polyethylene or a polytetrafluoroethylene, a fiberglass braid, or the like. The cable shield or outer conductor 106 is typically made of metal, such as aluminum or copper, and is often extruded to form a hollow tubular structure with a solid wall having a smooth exterior surface. An insulative cable jacket (not shown) may surround an outer surface 108 of the cable outer conductor 106 to further seal the coaxial cable 100. The cable jacket is typically made of plastic, such as polyvinylchloride, polyethylene, polyurethane, or polytetrafluoroethylene.

The connector 200 includes a plurality of components generally having a coaxial configuration about an axis defined by the center conductor 102 of the coaxial cable 100. The front nut assembly 300 includes a front body housing 310 supporting a terminal assembly 322 therein. Specifically, the front body housing 310 is formed with an axial bore configured to cooperatively contain the terminal assembly 322 and is made from an electrically conductive material such as aluminum, brass, or the like. The front body housing 310 is formed with an external threaded portion 326 at its forward end and a rearward external threaded portion 328 opposite the forward threaded portion 326. The forward threaded portion 326 is configured to cooperate with devices located in the field that receive the forward end of the pin assembly 322. An O-ring 320 may be provided around the forward threaded portion 326 to improve the seal that is made with a device and a portion of the exterior perimeter of the front body housing 310 may be provided with a hexagonal shape to accommodate the use of tools during installation. An insulative (i.e., non-conductive) body 312 maintains the position of the terminal assembly 322 in the front body housing 310. A seizure bushing 316 is urged forward into the front nut housing 310 by a mandrel 424 of the back nut assembly 400 (described below) during assembly and compresses a gripping portion 314 in the terminal assembly 322 around the center conductor 102 of the coaxial cable 100. The seizure bushing 316 has an extension 332 that extends into a groove 334 in the front body housing 310 to limit axial movement of the seizure bushing 316.

The rearward threaded portion 328 of the front nut assembly 300 is configured to cooperate with the back nut assembly 400. Specifically, the rearward threaded portion 328 includes a rim face 330 that cooperates with a mandrel 424 of the back nut assembly 400, as will be described in further detail below. An O-ring 318 may be provided around the rearward threaded portion 328 to improve the seal that is made with the back nut housing 410.

The back nut assembly 400 of the connector 200 includes a nut housing 410 having an axial bore and a compression subassembly rotatably supported within the axial bore. The compression subassembly generally includes the mandrel 424, a holder sleeve 416, a support sleeve 422, a cable gripping ferrule 418, and an O-ring 414 arranged in a coaxial relationship about the central axis of the back nut housing 410. The cable O-ring 414 is compressed axially by the holder sleeve 416 as the holder sleeve 416 is moved to the right in FIG. 1. This axial compression of the O-ring 414 causes the O-ring 414 to compress radially and form a water-proof seal between the nut housing 410 and the cable 100 upon assembly. The movement of the holder sleeve 416 to the right in FIG. 1 is limited by a rearward edge 468 of the holder sleeve 416 contacting an internal annular shoulder 458 of the back nut housing 410.

The back nut housing 410 is made from an electrically conductive material, such as aluminum, brass, or the like, and includes a forward internally threaded portion 452 configured to cooperate with the rearward threaded portion 328 of the front body housing 310 so that the two connector portions may be threadedly coupled together. The exterior surface of the back nut housing 410 is preferably provided with a hexagonal shape to accommodate the use of tools to facilitate such threaded coupling.

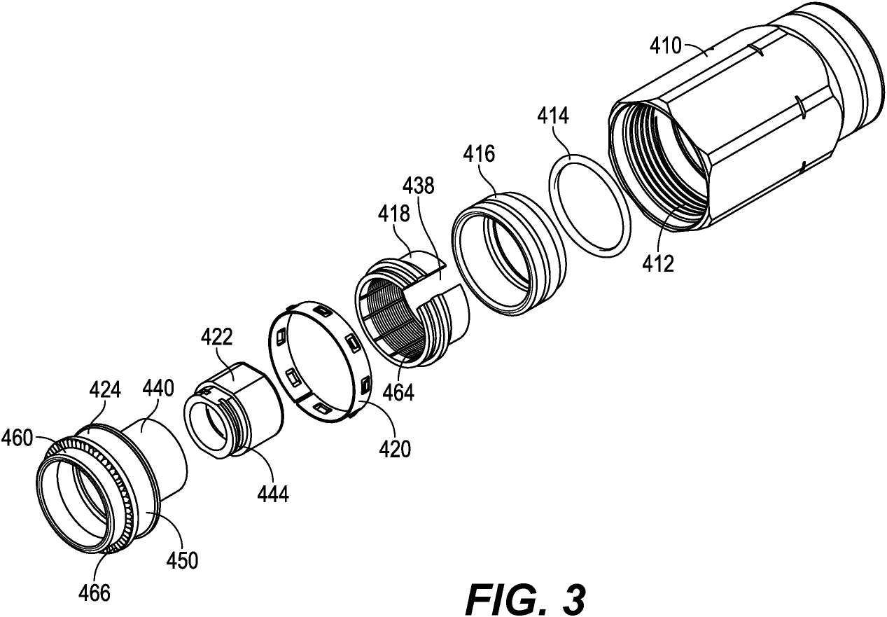

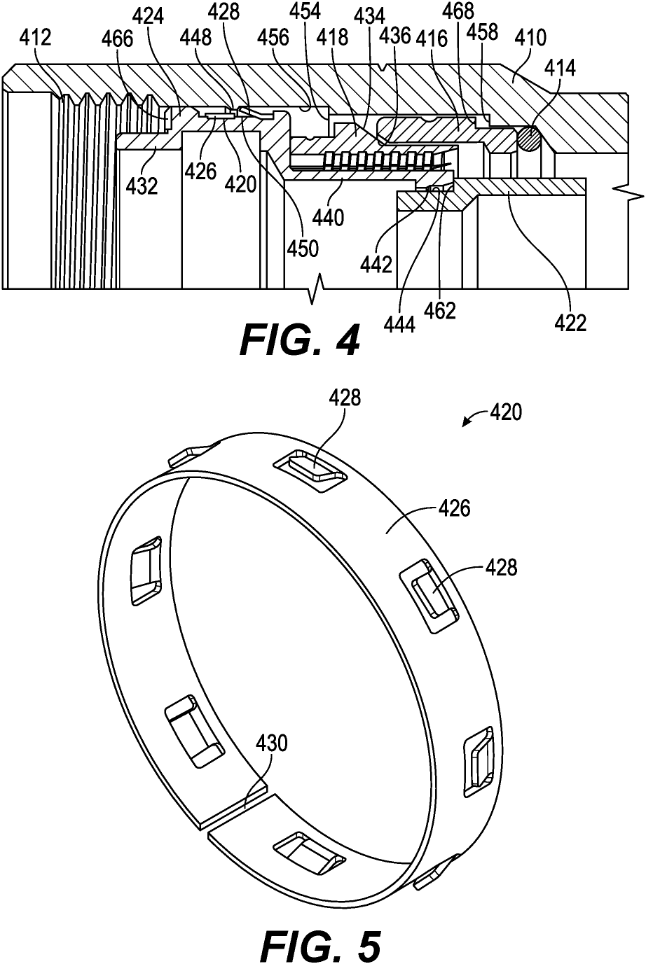

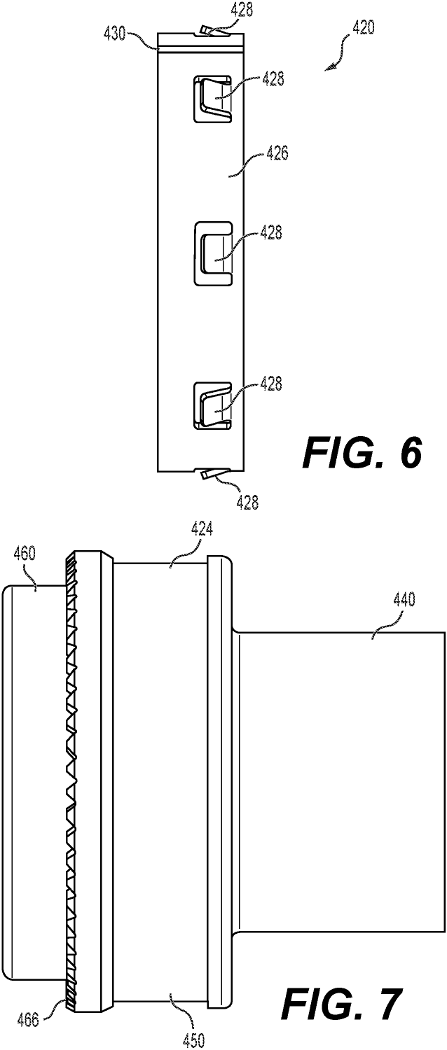

At its rearward end, the back nut housing 410 is formed with an axial bore dimensioned to receive the outside diameter of the cable 100 in snug fitting relationship. At its forward end, opposite the rearward end, the back nut housing 410 is formed with a forward axial bore communicating with the rearward axial bore and dimensioned to accommodate the outer diameter of the mandrel 424. For example, the internal surface of the back nut housing 410 may include an annular lip 448 and an annular shoulder 454 that define an annular groove 456 having an axial dimension. The annular groove 456 overlaps an annular groove 450 in an outer surface of the mandrel 424. A retaining ring 420 (see FIGS. 3-6) is located in the annular groove 450. The retaining ring 420 has a gap 430 that allows the diameter of the retaining ring 420 to be increased so that it can be positioned in the annular groove 450. The annular groove 456 receives a plurality of tabs 428 that extend radially outward from an annular body 426 of the retainer ring 420. As shown in FIG. 4, the tabs 428 engage the annular lip 448 and prevent the mandrel 424 (and thus the rest of the compression assembly) from moving axially toward the forward end of the back nut assembly 400. In embodiments, the tabs 428 are biased outwardly against the annular groove 456 such that the annular body 426 of the retaining ring 420 is biased against the annular groove 450 in the mandrel 424. This biasing results in the retaining ring 420 creating a secure electrically conductive connection between the mandrel 424 and the back nut housing 410. As shown in FIG. 4, the tabs 428 can move axially in the annular groove 456 between the annular lip 448 and the annular shoulder 454, and thus permit axial movement of the mandrel 424 relative to the back nut housing 410 within the axial dimension of the annular groove 456. The back nut housing 410 is also preferably formed with the internal annular shoulder 458 that limits rearward movement of the holder sleeve 416, and thus the gripping ferrule 418, as the gripping ferrule is radially compressed, as will be discussed in further detail below.

Along with the above-described retention feature of the tabs 428 of the retainer ring 420, the tabs 428 also provide an electrically conductive contact between the mandrel 424 and the back nut housing 410. The retainer ring 420, and thus the tabs 428, are made of a resilient material such as an electrically conductive metal that tries to return to its resting shape. For example, when the mandrel 424 is moved into the back nut housing 410 such that the tabs 428 move past annular lip 448, the tabs 428 spring radially outward to contact and press against groove 456. The resting diameter of outer edges of the tabs 428 is larger than the inner diameter of the groove 456 such that the resilient/spring nature of the tabs 428 maintain contact with the back nut housing 410 at the groove 456. Through this contact, a continuous and secure electrically conductive path is provided through the mandrel 424, the retaining ring 420, and the back nut housing 410. The retaining ring 420 ensures that the electrical path is provided when the back nut housing 410 is fully tightened to the front nut housing 310, when the back nut housing 410 is loosely tightened to the front nut housing 310, when the back nut housing 410 is partially tightened to the front nut housing 310, and when the back nut housing 410 is separated from the front nut housing 310. Because the back nut housing 410 and the front nut housing 310 are electrically conductive, an electrical path is created between the back nut housing 410 and the front nut housing 310.

The mandrel 424 (also shown in FIG. 7) includes a tubular body 440 terminating at a forward flanged head portion 460. The mandrel 424 may be made from a conductive metal. The outside diameter of the tubular body 440 of the mandrel 424 is dimensioned to be fitted within the inner diameter of the outer conductor 106 of the coaxial cable 100 (as shown in FIG. 1). Also, the inside diameter of the tubular body 440 is dimensioned to provide a passageway to receive the center conductor 102 of the cable 100 after the cable has been prepared for termination, wherein a length of the dielectric 104 has been removed from the forward end of the cable.

The support sleeve 422 is a tubular body made from plastic. The outside diameter of the support sleeve 422 is dimensioned to be fitted within the inner diameter of the outer conductor 106 of the coaxial cable 100. Also, the inside diameter of the support sleeve 422 is dimensioned to provide a passageway to receive the center conductor 102 of the cable 100 after the cable has been prepared for termination, wherein a length of the dielectric 104 has been removed from the forward end of the cable. A forward region of the support sleeve 422 includes a retention structure 444 configured to receive a complementary retention structure 442 at a rearward region of the mandrel 424. For example, as illustrated, the retention structure 444 may be an annular groove, and the retention structure 442 may be an annular projection. The retention structures 444, 442 cooperate to limit or prevent relative axial movement between the mandrel 424 and the support sleeve 422. The support sleeve 422 may also include a forward facing annular shoulder 462 that can engage a rearward edge of the mandrel 424. The plastic support sleeve 422 may have a thicker radial wall than the metal mandrel 424. The metal mandrel 424 has an axial length that extends into the gripping ferrule 418. The plastic support sleeve 422 has an axial length that extends from the metal mandrel 424 within the gripping ferrule 418 to the rearward axial bore of the back nut housing 410.

The holder sleeve 416 is preferably made from an electrically conductive material, such as aluminum or brass, and includes a sleeve body having an exterior surface configured to be received within the forward axial bore of the back nut housing 410. The sleeve body terminates at a rearward edge 468, which is configured to engage the annular shoulder 458 of the back nut housing 410.

The cable gripping ferrule 418 is generally in the form of a split tube having an axial gap 438 extending the full length of the ferrule. The gap 438 permits the diameter of the ferrule 418 to be reduced more easily so that the ferrule can be uniformly, radially compressed around the mandrel 424 and the support sleeve 422 upon rearward axial movement of the mandrel 424, as will be discussed in further detail below. The inner surface 464 of the gripping ferrule is preferably provided with structure to enhance gripping of the outer surface of the cable. Such structure may include internal threads, teeth or some other form of textured surface.

The outer surface of the cable gripping ferrule 418 is provided with a circumferential ramped portion 434, which engages a forward end 436 of the holder sleeve 416 upon rearward axial movement of the mandrel 424 and the support shaft 422 to radially compress the gripping ferrule 418. The ramped portion 434 defines a conical segment of the cable gripping ferrule 418 that tapers radially inwardly in the rearward direction. A rearward portion of the gripping ferrule 418 is received in an axial bore of the holder sleeve 416.

Operation and installation of the connector 200 will now be described. Initially, the end of the coaxial cable 100 that is to be inserted into the rearward end of the back nut housing 410 is prepared in a conventional manner. In particular, cable preparation entails removing about 0.75 inch (19.05 mm.) of the cable dielectric 104, the outer cable conductor 106 and the cable jacket to expose a portion of the center conductor 102 that will engage the pin-terminal assembly 322 of the front nut assembly 300 In addition, about 1.25 inches (31.75 mm.) of the cable dielectric 104 is removed from within the outer cable conductor 106 to provide clearance for the installation of the mandrel 424 and the support sleeve 422, and about 5 inches (127 mm.) of the cable jacket is removed to make an electrical connection with the inside surface of the cable gripping ferrule 418. After the cable end is prepared, it is inserted through the back nut housing 410 so that the portion of the center conductor 102 engages the gripping portion 314 of the terminal assembly 322. The above dimensions are presented as an example, the amount of the various components that are removed varies depending on the type of cable being used.

The back nut housing 410 is next threadedly coupled and rotated with respect to the front body housing 310 to translate the front nut and back nut assemblies 300, 400 together along their central axes. As the front nut and back nut assemblies 300, 400 are translated closer together, the rim face 330 of the front nut housing 310 engages a forward shoulder 466 of the mandrel 424 to translate the mandrel 424 and the support sleeve 422 towards the rear of the back nut housing 410. The interlocking mating surfaces 330, 466 of the front nut housing 310 and mandrel 424 cooperate to limit the amount of rotation between the front nut housing 310 and the mandrel 424. This limited relative rotation prevents or limits twisting of the coaxial cable 100 while the back nut housing 410 is threaded onto the front nut housing 310.

The rearward translation of the mandrel 424 and support sleeve 422 causes the outer ramp portion 434 of the gripping ferrule 418 to engage the forward end 436 of the holder sleeve 416, resulting in a radial compression of the gripping ferrule 418. The radial compression of the ferrule 418 reduces the overall diameter of the gripping ferrule 418 and reduces the axial gap 438 of the gripping ferrule 418 so that the inner textured surface 464 of the gripping ferrule 418 bites down on the exposed portion of the outer cable conductor 106 and presses the conductor against the mandrel 424 and the support sleeve 422. The inward radial pressure of the gripping ferrule 418 on the outer cable conductor 106 urges the cable outer conductor into contact with the tubular body 440 of the mandrel 424 to create an electrically conductive connection between the outer cable conductor 106 and the mandrel 424.

Because the resting diameter of outer edges of the tabs 428 is larger than the inner diameter of the groove 456, the resilient/spring nature of the tabs 428 maintain contact with the back nut housing 410 at the groove 456. Through this contact, a continuous and secure electrically conductive path is provided through the mandrel 424, the retaining ring 420, and the back nut housing 410.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable connector comprising:
a back coupler housing having a rearward end and a forward end opposite the rearward end;
a front coupler assembly configured to be coupled with the forward end of the back coupler housing;
a tubular metal mandrel configured to be received within the back coupler housing and having a rearward end portion;
a retaining ring configured to be received in a groove in an outer surface of the mandrel;
wherein the rearward end of the back coupler housing is configured to receive a cable;
wherein the retaining ring includes a main body and a plurality of tabs that are configured to protrude radially outward from the main body of the retaining ring;
wherein the tabs are configured to be biased outwardly against the back coupler housing such that main body of the retaining ring is biased against the groove in the outer surface of the mandrel;
wherein a compression assembly is configured to radially compress an outer conductor of the cable against the mandrel;
wherein the compression assembly includes a tubular gripping ferrule that is configured to radially surround the mandrel and a tubular holder sleeve that is configured to radially surround at least a portion of the gripping ferrule;
wherein the gripping ferrule is configured to be driven in an axial direction into engagement with the holder sleeve when the back coupler housing is threadedly coupled with the front coupler assembly, thereby causing the gripping ferrule to radially compress around the mandrel;
wherein the back coupler housing includes an inner surface having an annular groove configured to receive the tabs of the retaining ring so as to limit axial movement of the mandrel relative to the back coupler housing; and
wherein the main body of the retaining ring is configured to engage the outer surface of the mandrel, and the tabs are configured to engage an inner surface of the back coupler housing, thereby retaining the mandrel, the gripping ferrule, and the holder sleeve in the back coupler housing to prevent the mandrel, the gripping ferrule, and the holder sleeve from separating from the back coupler housing before the back coupler housing is coupled with the front coupler assembly and electrically connecting the mandrel to the back coupler housing to provide an electrical path from the outer conductor of the cable to the back coupler housing even before the back coupler housing is fully tightened to the front coupler assembly.

2. The connector of claim 1, wherein the electrical path is provided when the back coupler housing is fully tightened to the front coupler assembly and during operation of the connector, and wherein the connector comprises a coaxial cable connector.

3. The connector of claim 1, wherein the electrical path is provided when the back coupler housing is loosely tightened to the front coupler assembly.

4. The connector of claim 1, wherein the electrical path is provided when the back coupler housing is partially tightened to the front coupler assembly and during operation of the connector.

5. The connector of claim 1, wherein the electrical path is provided when the back coupler housing is separated from the front coupler assembly and during operation of the connector.

6. The connector of claim 1, wherein the front coupler assembly comprises a front nut assembly; and wherein the back coupler housing comprises a back nut housing.

7. A cable connector comprising:
a first portion having a rearward end and a forward end opposite the rearward end;
a second portion configured to be coupled with the forward end of the first portion;
an outer conductor engager portion configured to be supported within the first portion and having a rearward end portion;
a retaining portion configured to be received in a groove in an outer surface of the outer conductor engager portion;
wherein the rearward end of the first portion is configured to receive a cable;
wherein the retaining portion includes a main body and an engagement portion that is configured to protrude radially outward from the main body of the retaining portion; and
wherein the main body of the retaining portion is configured to engage the outer surface of the outer conductor engager portion and the engagement portion is configured to engage an inner surface of the first portion, thereby retaining the outer conductor engager portion in the first portion to prevent the outer conductor engager portion from separating from the first portion before first portion is coupled with the second portion and electrically connecting the outer conductor engager portion to the first portion to provide an electrical path from the cable to the first portion even before the first portion is fully tightened to the second portion.

8. The connector of claim 7, wherein the electrical path is provided when the first portion is fully tightened to the second portion and during operation of the connector, wherein the connector comprises a coaxial cable connector, and wherein the electrical path is provided when the first portion is loosely tightened to the second portion and during operation of the connector.

9. The connector of claim 7, wherein the electrical path is provided when the first portion is partially tightened to the second portion and during operation of the connector.

10. The connector of claim 7, wherein the electrical path is provided when the first portion is separated from the second portion and during operation of the connector.

11. The connector of claim 7, wherein the first portion comprises a back nut housing, the second portion comprises a front nut assembly, the retaining portion comprises a retaining ring, and the engagement portion comprises a plurality of tabs, and wherein the connector comprises a coaxial cable connector.

12. The connector of claim 7, wherein the engagement portion is configured to be biased outwardly against the first portion such that the retaining portion is biased against the groove in the outer surface of the outer conductor engager portion.

13. The connector of claim 7, further comprising a compression assembly that is configured to radially compress an outer conductor of the cable against the outer conductor engager portion.

14. The connector of claim 13, wherein the compression assembly includes a tubular gripping ferrule that radially surrounds at least a portion of the outer conductor engager portion and a tubular holder sleeve that radially surrounds at least a portion of the gripping ferrule, and the gripping ferrule is configured to be driven in an axial direction into engagement with the holder sleeve when the first portion is threadedly coupled with the second portion so as to cause the gripping ferrule to radially compress around the outer conductor engager portion.

15. The connector of claim 7, wherein the first portion includes an inner surface having an annular groove that is configured to receive the engagement portion of the retaining portion and to limit axial movement of the outer conductor engager portion relative to the first portion, and wherein the inner surface of the first portion comprises an annular lip that is configured to engage the engagement portion.

16. A connector comprising:
a first coupler portion configured to receive a cable;
a second coupler portion configured to be coupled with the first coupler portion;
an outer conductor engager portion configured to be supported in at least a portion of the first coupler portion;
a retaining portion configured to be received by the outer conductor engager portion during assembly of the connector; and
wherein the retaining portion is configured to engage the outer conductor engager portion so as to retain the outer conductor engager portion in at least a portion of the first coupler portion and restrict the outer conductor engager portion from separating from the first coupler portion before the second coupler portion is coupled to the first coupler portion and electrically connect the outer conductor engager portion to the first coupler portion so as to provide an electrical path from the cable to the first coupler portion during operation of the connector.

17. The connector of claim 16, wherein and the retaining portion is configured to engage the first coupler portion.

18. The connector of claim 16, wherein the first coupler portion comprises a back nut housing portion, the second coupler portion comprises a front nut assembly, the outer conductor engage portion comprises a tubular mandrel, and the retaining portion comprises a retaining ring.

19. The connector of claim 16, wherein the electrical path is provided when the first coupler portion is fully tightened to the second coupler portion and during operation of the connector, and wherein the connector comprises a coaxial cable connector.

20. The connector of claim 16, wherein the electrical path is provided when the first coupler portion is loosely tightened to the second coupler portion and during operation of the connector, when the first coupler portion is partially tightened to the second coupler portion and during operation of the connector, and when the first portion is separated from the second portion and during operation of the connector.

21. The connector of claim 16, wherein the outer conductor engager portion is configured to be supported within the first coupler portion.

22. The connector of claim 16, further comprising a compression assembly that is configured to radially compress an outer conductor of the cable against the outer conductor engager portion.
